(19) United States
(12) Patent Application Publication
(10) Pub. No.: US 2025/0392183 A1
(43) Pub. Date: Dec. 25, 2025

(54) EMOTOR BUSBAR WITH WELDED OR CLAMPED FIXATION POINT

(71) Applicant: Schaeffler Technologies AG & Co. KG, Herzogenaurach (DE)

(72) Inventors: John Ramsey, Mansfield, OH (US); Micah Steiner, Creston, OH (US); Brian Foust, Lakewood, OH (US)

(73) Assignee: Schaeffler Technologies AG & Co. KG, Herzogenaurach (DE)

(21) Appl. No.: 18/753,234

(22) Filed: Jun. 25, 2024

(51) Int. Cl. H02K 3/50; H02K 1/16; H02K 3/28

(52) U.S. Cl. CPC H02K 3/50; H02K 1/16; H02K 3/28; H02K 2203/09

(57) ABSTRACT

A stator assembly for an electric motor includes a stator carrier that extends along an axis between a first side and a second side and defines an opening. A tab formed of a first metal material is located on one of the first side or the second side. A plurality of windings are located in the opening and at least one bus bar is in conductive communication with the plurality of windings. A bus bar carrier formed of a plastic material includes a body that supports the at least one bus bar. The body includes a projection at least partially formed of a second metal material extending towards the tab. The tab and the projection are connected by at least one of a weld bond or a clamp connection.

### FIELD OF THE DISCLOSURE

The present disclosure generally relates to a stator assembly that includes a bus bar and a plurality of windings coupled to a stator carrier and, more particularly, a system for connecting the bus bar to the stator carrier.

### BACKGROUND OF THE DISCLOSURE

Electric motors typically include a housing with a rotor and a stator located in the housing. The stator typically includes a bus bar a plurality of windings coupled to a stator carrier and, during usage, relative movements, such as vibration, can cause the bus bar to become dislodged or loose from the stator carrier.

### SUMMARY OF THE DISCLOSURE

According to a first aspect of the present disclosure, a stator assembly for an electric motor includes a stator carrier that extends along an axis between a first side and a second side and defines an opening. A tab formed of a first metal material is located on one of the first side or the second side. A plurality of windings are located in the opening and at least one bus bar is in conductive communication with the plurality of windings. A bus bar carrier formed of a plastic material includes a body that supports the at least one bus bar. The body includes a projection at least partially formed of a second metal material extending towards the tab. The tab and the projection are connected by at least one of a weld bond or a clamp connection.

Embodiments of the first aspect of the disclosure can include any one or a combination of the following features:
the tab and the projection are connected by the clamp connection.
one of the projection or the tab defines arms extending around the other of the projection or the tab.
the tab defines the arms and the projection defines opposing depressions and the arms are at least partially located in the opposing depressions.
the projection includes an insert formed of the second metal material.
the insert includes a leg that extends to a boot extending traverse to the leg.
the boot defines opposing depressions and the tab is at least partially located in the opposing depressions.
the leg includes a first leg portion that extends from the body of the bus bar carrier and a second leg portion that extends from the first leg portion to the boot. The second leg portion extends at a transverse angle from the first leg portion.
the boot extends from the leg in a direction substantially perpendicular to the axis.
the tab and the projection are connected by the weld bond.
the weld bond is one of a lap weld or a butt weld.
the weld bond is a laser weld bond.
the first metal material and the second metal material are the same.

According to a second aspect of the present disclosure, a stator assembly for an electric motor includes a stator carrier. The stator carrier extends along an axis between a first side and a second side, defines an opening, and includes a surface at least partially formed of a first metal material. A plurality of are windings located in the opening and at least one bus bar is in conductive communication with the plurality of windings. A bus bar carrier formed of a plastic material includes a body that supports the at least one bus bar. The body includes at least one projection at least partially formed of a second metal material that extends towards and is aligned with the surface of the stator carrier. The surface of the stator carrier and the at least one projection are connected by at least one of a weld bond or a clamp connection.

Embodiments of the second aspect of the disclosure can include any one or a combination of the following features:
the surface of the stator carrier and the at least one projection are connected by the clamp connection.
the at least one projection or the surface of the stator carrier define arms extending around the other of the at least one projection or the surface of the stator carrier.
the surface of the stator carrier and the projection are connected by the weld bond.
the at least one projection includes a plurality of projections connected to the surface of the stator carrier.

According to a third aspect of the present disclosure, a stator assembly for an electric motor includes a stator carrier that extends along an axis between a first side and a second side and defines an opening. A tab formed of a first metal material is located on one of the first side or the second side. A plurality of windings are located in the opening and at least one bus bar is in conductive communication with the plurality of windings. A bus bar carrier formed of a plastic material includes a body that supports the at least one bus bar. The body includes a projection with an insert formed of a second metal material extending towards the tab. The tab and the projection are connected by at least one of a weld bond or a clamp connection.

Embodiments of the third aspect of the disclosure can include any one or a combination of the following features:
the insert includes a leg extending from the body to a boot, and the boot extends at a transverse angle from the leg.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side view of a stator assembly with a stator carrier and a bus bar carrier connected to the stator carrier;

FIG. 2 is a schematic side view of an electric motor having a stator assembly with a stator carrier and a bus bar carrier connected to the stator carrier;

FIG. 3 is a top view of a stator assembly with a stator carrier and a bus bar carrier connected to the stator carrier;

FIG. 4 is a schematic side view of a stator carrier and a bus bar carrier connected to the stator carrier with a weld bond;

FIG. 5A is a schematic side view of a stator carrier and a bus bar carrier connected to the stator carrier with a first clamp connection;

FIG. 5B is a schematic side view of a stator carrier and a bus bar carrier connected to the stator carrier with a second clamp connection;

FIG. 5C is a top perspective isolated view of a clamp connection between an insert of a bus bar carrier and a tab of a stator carrier;

FIG. 6 is a schematic side view of a stator carrier and a bus bar carrier connected to the stator carrier with a weld bond and a clamp connection; and

FIG. 7 is a top perspective view of a stator carrier with a bus bar carrier supporting a plurality of bus bars.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along the axis of a shaft configured to rotate in operation of the apparatus described herein. Further, the term “radial” and derivatives thereof, such as “radially,” shall be understood in relation to the axis of the aforementioned shaft. For example, “radially outboard” refers to further away from the axis, while “radially inboard” refers to nearer to the axis.

As used herein, the term “plurality” shall be understood to refer to two or more. The term “weld bond” shall be understood to refer to a member that welded to another member with or without additional filler rod material.

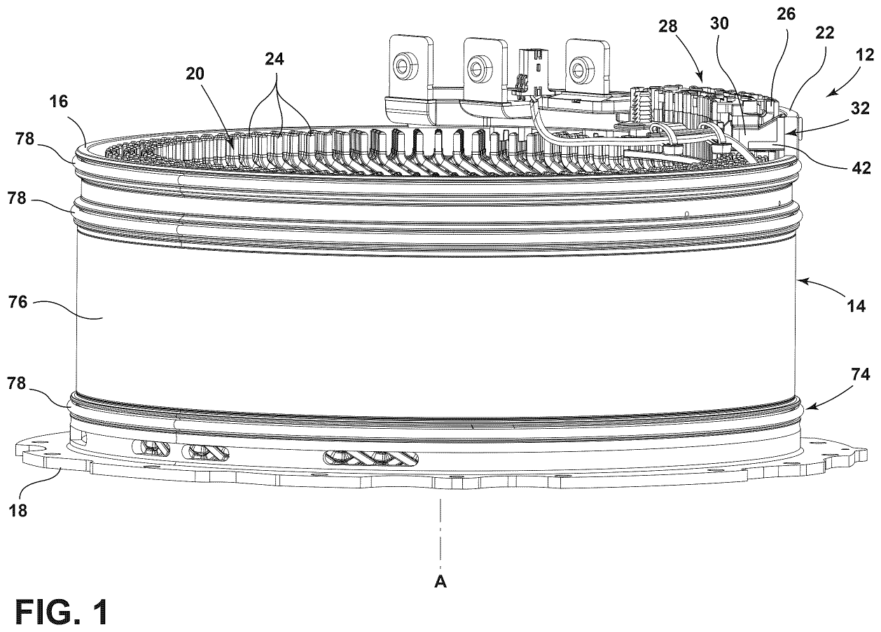

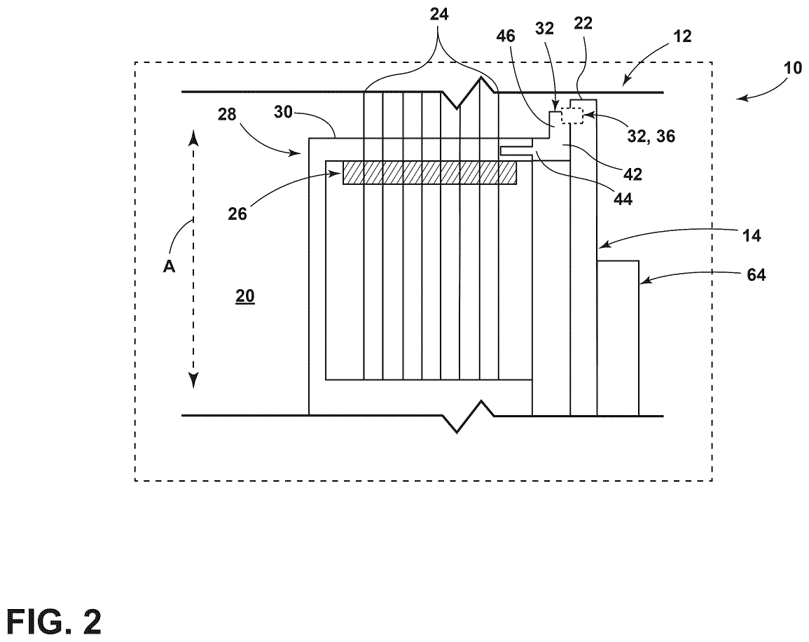

Referring now to FIGS. 1 and 2, reference numeral 10 generally designates an electric motor 10. The electric motor 10 includes a stator assembly 12 having a stator carrier 14 that extends along an axis A between a first side 16 and a second side 18 and defines an opening 20. A tab 22 formed of a first metal material is located on one of the first side 16 or the second side 18. A plurality of windings 24 are located in the opening 20 and at least one bus bar 26 is in conductive communication with the plurality of windings 24. A bus bar carrier 28 formed of a plastic material includes a body 30 that supports the at least one bus bar 26. The body 30 includes a projection 32 at least partially formed of a second metal material extending towards the tab 22. The tab 22 and the projection 32 are connected by at least one of a weld bond 34 or a clamp connection 36.

With continued reference to FIGS. 1-3, in some embodiments the stator carrier 14 may be connected to a plurality of bus bar carriers 28, with each bus bar carrier 28 having a projection 32. More particularly, the stator carrier 14 may include a plurality of tabs 22 or a surface connected to different ones of the bus bar carriers 28. In some embodiments, each bus car carrier 28 may include a plurality (e.g., two or more, three or more, etc.) of projections 32 that extend towards and align with the plurality of tabs 22 or surface of the stator carrier 14. The body 30 of the bus bar carrier 28 may extend between a first end 38 and a second end 40 and at least one of the plurality of projections 32 is proximate the first end 38 and at least one of the plurality of projections 32 is proximate the second end 40. In some embodiments, at least one of the plurality of projections 32 is located between the first end 38 and the second end 40. For example, one of the plurality of projections 32 may be located substantially centrally between the first end 38 and the second end 40. The bus bar carrier 28 may be shaped to support multiple bus bars 26. Each bus bar 26 is formed of a conductive material (e.g., copper) and in conductive communication with the plurality of windings 24.

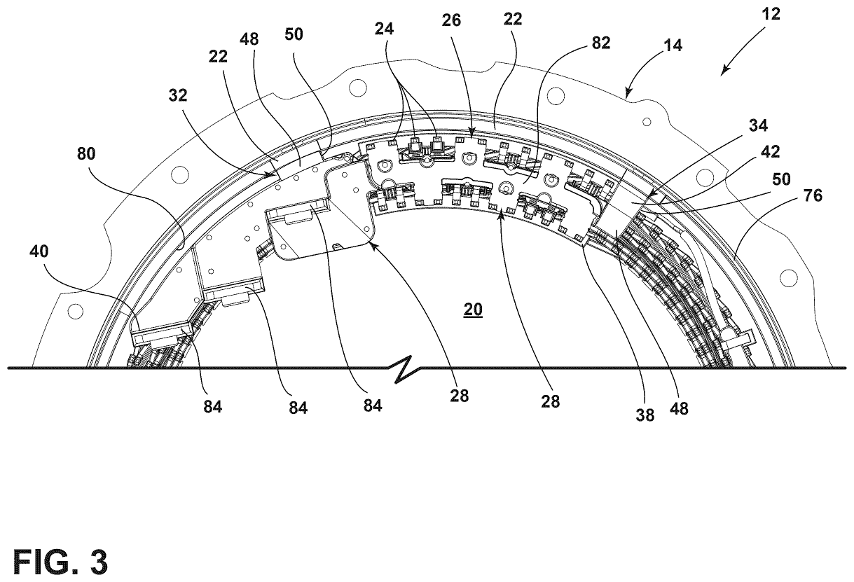

With reference now to FIG. 3, the stator carrier 14 may extend about the axis A circumferentially around the axis A. The bus bar carrier 28 or carriers 28 may likewise, extend around the axis A circumferentially. In some embodiments, the tabs 22 may also extend around the axis A circumferentially. The projections 32 may each include an insert 42. The insert 42 may be formed to the second metal material. In some embodiments, the body 30 (e.g., the projection 32) may be molded over the insert 42. In other embodiments, the insert 42 is attached to the projection 32 by other means, such as adhesives, threads, fasteners, pins, combinations thereof, and/or the like.

With continued reference to FIGS. 1-3, the insert 42 may include a leg 44 that extends transverse to a boot 46. The insert 42 may include a generally flat shape defined by two opposing surfaces 48 and side edges 50. In this manner, the opposing surfaces 48 may be spaced by a distance less than a spacing between the side edges 50. The first metal material and the second metal material may be the same or different. In some embodiments, one or both of the first metal material and the second metal material are formed of steel. The boot 46 may extend traverse to the leg 44. In some embodiments, the boot 46 extends substantially perpendicular to the leg 44. The leg 44 may extend substantially perpendicular to the axis A and the boot 46 may extend substantially parallel to the axis A. More particularly, the boot 46 extends from the leg 44 to a distal end 52 substantially parallel to the axis A. The boot 46 defines an exterior surface 54 and the tab 22 defines an interior surface 56 that faces the boot 46. The exterior and interior surfaces 54, 56 may define contours that are substantially matched. For example, the exterior and interior surfaces 54, 56 may be flat, extend circumferential relative to the axis A, or define other shapes. In some embodiments, the boot 46 (e.g., the exterior surface 54) may directly abut the tab 22 (e.g., the interior surface 56). In other embodiments, an intermediate structure, such as a spacer (e.g., filler rod material) may be located between and space the exterior and interior surfaces 54, 56. It should be appreciated, however, that the insert 42 may connect to the stator carrier 14 without tabs 22. More particularly, the stator carrier 14 includes an interior carrier surface 80 and the insert 42 may connect to a surface of the stator carrier 14, such as the interior carrier surface 80.

With continued reference to FIGS. 1-3, the leg 44 may define a first leg portion 58 and a second leg portion 60. The first leg portion 58 may extend from the body 30 of the bus bar carrier 28 and the second leg portion 60 may extend from the first leg portion 58 to the boot 46. In some embodiments, the second leg portion 60 extends at a transverse angle from the first leg portion 58. More particularly, the first leg portion 58 may extend in a first direction substantially perpendicular to the axis A and the second leg portion 60 may extend in a second direction transverse (e.g., perpendicular) to the first leg portion 58 and the axis A. However, it should be appreciated that the leg 44 may be generally straight or other shapes.

The tab 22 (or other surface of the stator carrier 14) is formed of the first metal material (e.g., aluminum, steel, etc.) and the projection 32 is formed at least partially of the plastic material (e.g., formed of the plastic material except for the insert 42). For example, the bus bar carrier 28 may be formed of the plastic material and the stator carrier 14 may be formed of the first metal material and integral with the tab 22. The tab 22 may extend from the stator carrier 14 to a distal edge 62 substantially parallel to the axis A. In other embodiments, the tab 22 may extend from the stator carrier 14 to the distal edge 62 substantially perpendicular to the axis A. The stator assembly 12 depicted in FIGS. 1 and 2 is for the electric motor 10. The electric motor 10 may include a motor housing 64 exterior to and coupled with the stator carrier 14. The motor housing 64 may likewise be formed of a third metal material, which may be the same or different than the first and second metal materials (e.g., aluminum, steel, etc.).

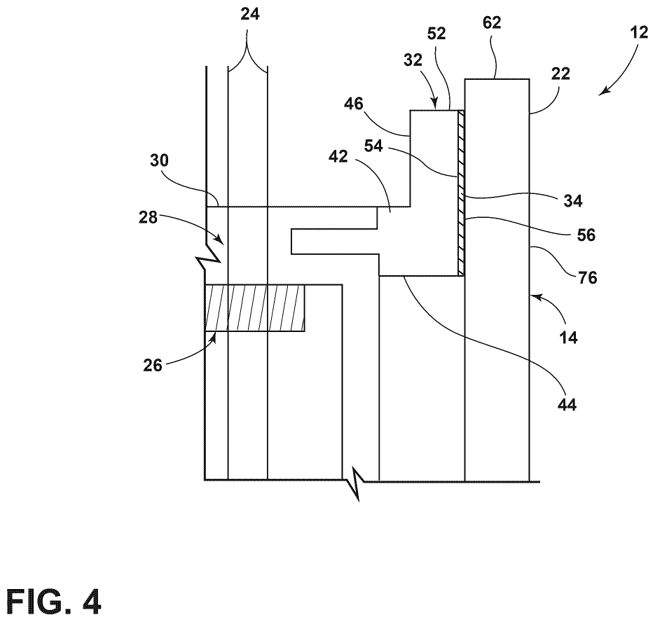

With reference now to FIGS. 4-6, the tab 22 (or other surface of the stator carrier 14) and the projection 32 (e.g., the boot 46 of the insert 42) are connected by at least one of the weld bond 34 or the clamp connection 36. In other words, the tab 22 and the projection 32 (e.g., the boot 46 of the insert 42) are connected by the weld bond 34 and not the clamp connection 36, the clamp connection 36 and not the weld bond 34, or both the weld bond 34 and the clamp connection 36.

As depicted in FIG. 4, the tab 22 (or other surface of the stator carrier 14) and the projection 32 (e.g., the boot 46 of the insert 42) are connected by the weld bond 34. In some embodiments, the weld bond 34 is one of a lap weld or a butt weld. In some embodiments, the weld bond 34 is a laser weld bond. The weld bond 34 may be formed of the first metal material, the second metal material, or both the first and second metal materials. More particularly, the weld bond 34 may include the first and/or second metal materials that have been liquified by heat and allowed to cool into a solid. In some embodiments, the weld bond 34 may include the filler rod material alternatively or in addition to the first and/or second metal materials.

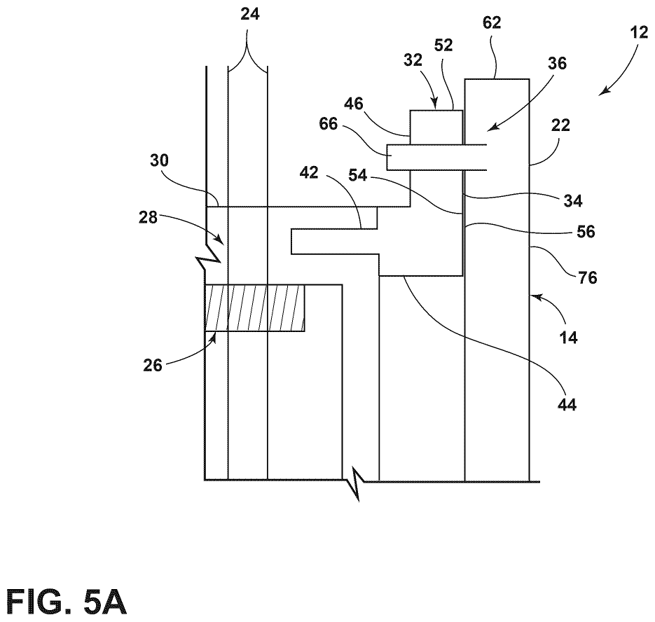

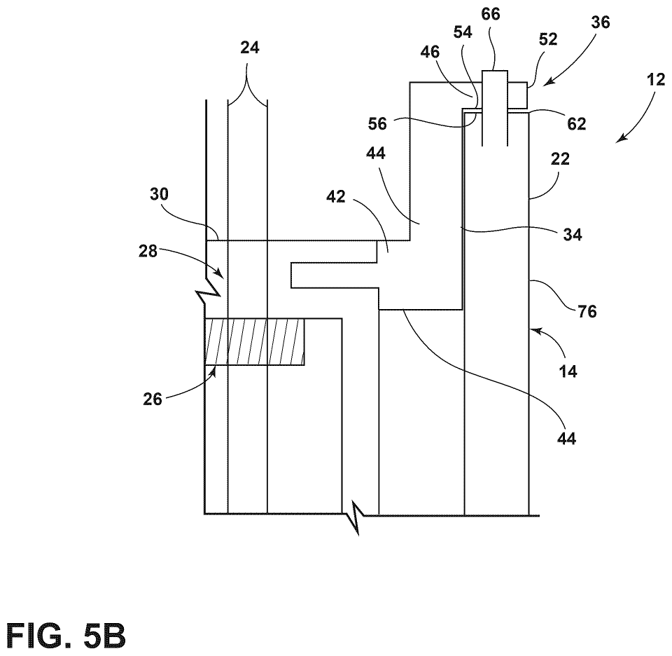

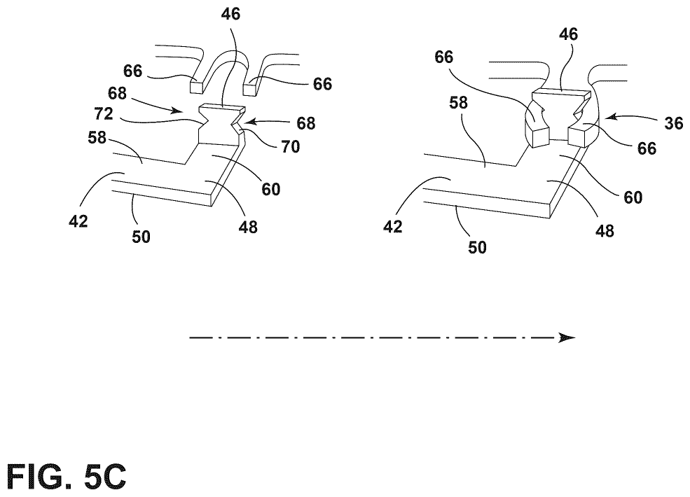

As depicted in FIG. 5A-5C, the tab 22 (or other surface of the stator carrier 14) and the projection 32 (e.g., the boot 46 of the insert 42) are connected by the clamp connection 36. More particularly, one of the projection 32 (e.g., the boot 46 of the insert 42) or the tab 22 defines arms 66 extending around the other of the projection 32 (e.g., the boot 46 of the insert 42) or the tab 22. In some embodiments, the tab 22 (or other surface of the stator carrier 14) defines the arms 66 and the projection 32 defines opposing depressions 68 and the arms 66 are at least partially located in the opposing depressions 68. More particularly, the opposing depressions 68 are each defined by depression walls 70 (e.g., formed in the side edges 50 of the insert 42) that are angled, curved, or otherwise formed inwardly to a depression bottom 72. During assembly, the projections 32 (e.g., the boot 46 of the insert 42) are aligned with the tabs 22 and inserted between the arms 66, where the arms 66 are deformed into clamping engagement with the projections 32 (e.g., the boot 46 of the insert 42) to form the clamp connection 36. The arms 66 may be integral with the tab 22 and formed of the first metal material. The arms 66 in the clamp connection 36 may extend along the axis A (FIG. 5B), transverse (e.g., perpendicular) to the axis A (FIG. 5A), or both (e.g., a first pair of arms 66 that extend along the axis A and a second pair of arms 66 that are transverse to the axis A).

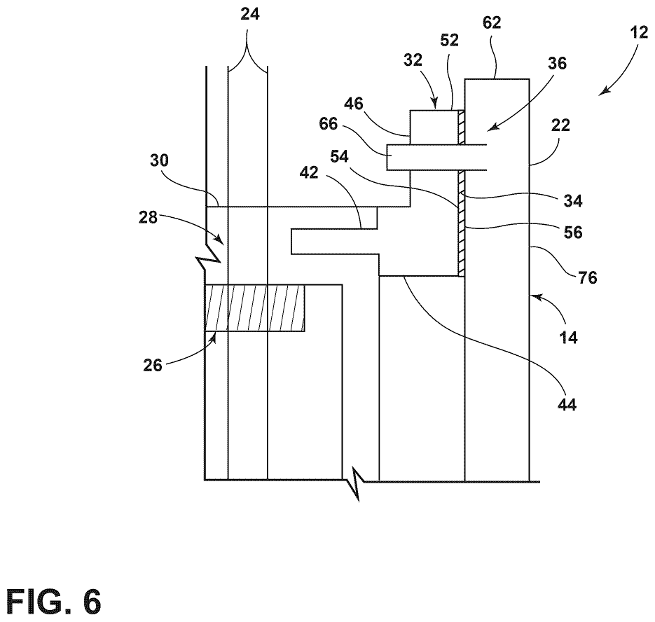

As depicted in FIG. 6, the tab 22 (or other surface of the stator carrier 14) and the projection 32 (e.g., the boot 46 of the insert 42) are connected by both the weld bond 34 and the clamp connection 36. More particularly, the weld bond 34 depicted in FIG. 6 may include any and all materials, features, and structures as the weld bond 34 depicted in FIG. 4. The clamp connection 36 depicted in FIG. 6 may, likewise, include any and all materials, features, and structures as the clamp connection 36 depicted in FIGS. 5A-5C.

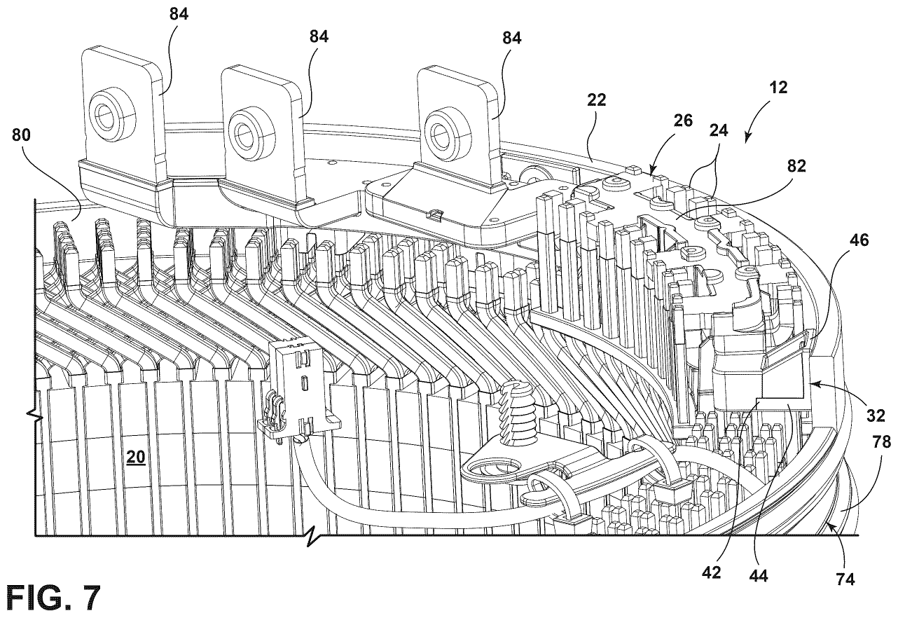

With reference now to FIG. 7, the bus bar carrier 28 may have a multi-piece or single-piece construction. In some embodiments, the boot 46 may extend along the axis A greater distance that the leg 44. The stator carrier 14 may include one or more channels 74 defined on an exterior carrier surface 76 and a gasket 78 may be located in each channel 74. The interior carrier surface 80 may define the opening 20. The stator carrier 14 defines a thickness between the exterior carrier surface 76 and the interior carrier surface 80. In some embodiments, the tabs 22 have a thickness that is less than the thickness of the stator carrier 14. For example, the tabs 22 may be flush with the exterior carrier surface 76 and spaced from the interior carrier surface 80, flush with the interior carrier surface 80 and spaced from the exterior carrier surface 76, or spaced from both the exterior carrier surface 76 and the interior carrier surface 80 (e.g., centrally). However, it should be appreciated that, in some embodiments, the tabs 22 have a thickness that is equal to the thickness of the stator carrier 14.

With continued reference to FIG. 7, the bus bar carrier 28 may define multiple holes that the windings 24 can be inserted into. The bus bars 26 may include a main body portion 82 and bus tabs 84 extending into conductive communication with select windings 24. In some embodiments, each of the plurality of bus bars 26 is in conductive communication with different ones of the windings 24. It should be appreciated that, unless explicitly stated, the electric motor 10 may be incorporated into any structure (e.g., an electric axle or other components of a vehicle) and/or utilized for any function where it is beneficial to reduce relative movement (e.g., vibration) and/or secure the connection between the stator carrier 14 and/or the bus bar carrier 28 and the motor housing 64.

With reference now to FIGS. 1-7, the tab 22 may include a plurality of tabs 22 connected (e.g., the weld bond 34, the clamp connection 36, or both) to different ones (e.g., one or more) of the projections 32 or a single tab 22 connected to a each of the projections 32. In some embodiments, the projections 32 are connected to a surface of the stator carrier 14 other than tabs 22 (e.g., the weld bond 34, the clamp connection 36, or both). For example, the surface of the stator carrier 14 may include one or more portions of the interior carrier surface 80, the exterior carrier surface 76, the first side 16, the second side 18, and/or combinations thereof.

It is to be understood that variations and modifications can be made on the aforementioned structure without departing from the concepts of the present disclosure, and further it is to be understood that such concepts are intended to be covered by the following claims unless these claims by their language expressly state otherwise.

### LIST OF REFERENCE NUMERALS

A axis
10 electric motor
12 stator assembly
14 stator carrier
16 first side
18 second side
20 opening
22 tab
24 windings
26 bus bar
28 bus bar carrier
30 body
32 projection
34 weld bond
36 clamp connection
38 first end
40 second end
42 insert
44 leg
46 boot
48 opposing surfaces
50 side edges
52 distal end
54 exterior surface
56 interior surface
58 first leg portion
60 second leg portion
62 distal edge
64 motor housing
66 arms
68 depressions
70 depression walls
72 depression bottom
74 channel
76 exterior carrier surface
78 gasket
80 interior carrier surface
82 main body portion
84 bus tabs

What is claimed is:

1. A stator assembly for an electric motor, comprising:
a stator carrier extending along an axis between a first side and a second side and defining an opening,
a tab formed of a first metal material located on one of the first side or the second side;
a plurality of windings located in the opening and at least one bus bar in conductive communication with the plurality of windings;
a bus bar carrier formed of a plastic material including a body that supports the at least one bus bar, the body includes a projection at least partially formed of a second metal material extending towards the tab; and
wherein the tab and the projection are connected by at least one of a weld bond or a clamp connection.

2. The stator assembly of claim 1, wherein the tab and the projection are connected by the clamp connection.

3. The stator assembly of claim 2, wherein one of the projection or the tab defines arms extending around the other of the projection or the tab.

4. The stator assembly of claim 3, wherein the tab defines the arms and the projection defines opposing depressions and the arms are at least partially located in the opposing depressions.

5. The stator assembly of claim 3, wherein the projection includes an insert formed of the second metal material.

6. The stator assembly of claim 5, wherein the insert includes a leg that extends to a boot extending traverse to the leg.

7. The stator assembly of claim 6, wherein the boot defines opposing depressions and the tab is at least partially located in the opposing depressions.

8. The stator assembly of claim 7, wherein the leg includes a first leg portion extending from the body of the bus bar carrier and a second leg portion extending from the first leg portion to the boot, and wherein the second leg portion extends at a transverse angle from the first leg portion.

9. The stator assembly of claim 6, wherein the boot extends from the leg in a direction substantially perpendicular to the axis.

10. The stator assembly of claim 1, wherein the tab and the projection are connected by the weld bond.

11. The stator assembly of claim 10, wherein the weld bond is one of a lap weld or a butt weld.

12. The stator assembly of claim 10, wherein the weld bond is a laser weld bond.

13. The stator assembly of claim 10, wherein the first metal material and the second metal material are the same.

14. A stator assembly for an electric motor, comprising:
a stator carrier extending along an axis between a first side and a second side, defining an opening, and including a surface at least partially formed of a first metal material,
a plurality of windings located in the opening and at least one bus bar in conductive communication with the plurality of windings;
a bus bar carrier formed of a plastic material including a body that supports the at least one bus bar, the body includes at least one projection at least partially formed of a second metal material, the at least one projection extending towards and aligned with the surface of the stator carrier; and
wherein the surface of the stator carrier and the at least one projection are connected by at least one of a weld bond or a clamp connection.

15. The stator assembly of claim 14, wherein the surface of the stator carrier and the at least one projection are connected by the clamp connection.

16. The stator assembly of claim 15, wherein the at least one projection or the surface of the stator carrier defines arms extending around the other of the at least one projection or the surface of the stator carrier.

17. The stator assembly of claim 14, wherein the surface of the stator carrier and the at least one projection are connected by the weld bond.

18. The stator assembly of claim 17, wherein the at least one projection includes a plurality of projections connected to the surface of the stator carrier.

19. A stator assembly for an electric motor, comprising:
a stator carrier extending along an axis between a first side and a second side and defining an opening,
a tab formed of a first metal material located on one of the first side or the second side;
a plurality of windings located in the opening and at least one bus bar in conductive communication with the plurality of windings;
a bus bar carrier formed of a plastic material including a body that supports the at least one bus bar, the body includes a projection with an insert formed of a second metal material extending towards the tab; and
wherein the tab and the projection are connected by at least one of a weld bond or a clamp connection.

20. The stator assembly of claim 19, wherein the insert includes a leg extending from the body to a boot, and the boot extends at a transverse angle from the leg.
